(19) United States
(12) Patent Application Publication
(10) Pub. No.: US 2006/0289768 A1
(43) Pub. Date: Dec. 28, 2006

(54) Portable infrared camera

(76) Inventors: Frank Vallese, Montville, NJ (US); John Armstrong, Branchburg, NJ (US); Robert DeMarco, Whippany, NJ (US); Gerard DiTaranto, Parsippany, NJ (US); James LaGrotta, Boonton Twp., NJ (US); Art Stout, Franklin Lakes, NJ (US); Ronald Walsh, Hacketstown, NJ (US)

Correspondence Address: HOFFMAN, WASSON & GITLER, P.C., Suite 522, 2461 South Clark Street, Arlington, VA, 22202, US

(21) Appl. No.: 11/408,919

(22) Filed: Apr. 24, 2006

Related U.S. Application Data
(60) Provisional application No. 60/673,802, filed on Apr. 22, 2005.

(51) Int. Cl. G01J 5/02

(52) U.S. Cl. 250/353

(57) ABSTRACT

An infrared camera provided with a rotating lens. The exterior of the camera is also provided with a touch screen display as well as a switch device such as a 5-way switch, controlling many of the functions of the infrared camera. The rotation of the lens would allow an operator to view different objects while maintaining a single position, allowing the operator to view the material projected on the display very easily. A trigger would be used to capture a particular infrared image and to save this image as well as to transmit it, at a later time, to a personal computer.

### CROSS-REFERENCED APPLICATION

The present invention claims the benefit of the priority date of U.S. Provisional Patent Application Ser. No. 60/673,802, filed Apr. 22, 2005.

### FIELD OF THE INVENTION

The present invention is generally related to the field of infrared thermography.

### BACKGROUND OF THE INVENTION

All surfaces emit thermal radiation. At a given surface temperature, there is a maximum amount of radiation that any surface can emit. If the surface emits this maximum amount of radiation, it is known as a blackbody. Most surfaces are not blackbody emitters, and emit some fraction of the amount of thermal radiation that a blackbody would emit. This fraction is known as the emissivity. For example, if a surface emits half as much radiation at a given wavelength and temperature as a blackbody, it is said to have an emissivity of 0.5. By this definition, a blackbody has an emissivity of 1.0 at all temperatures and wavelengths.

Prior art portable thermal imaging cameras that have been developed measure the amount of thermal radiation emitted by an object and, with knowledge of the emissivity of that object, surmise the temperature of the object. When initially developed, these infrared cameras were quite bulky and were difficult to maneuver. However, as development has progressed, the size of these cameras has been reduced, thereby facilitating their maneuverability, and their use in the field.

An example of a marginally maneuverable infrared camera is described in U.S. Pat. No. 5,637,871, issued to Piety et al. As illustrated in FIG. 2, an infrared camera 54 can be taken into the field to conduct various thermographic inspections. This camera is used in conjunction with a vest 60 worn by an inspector. The vest 60 is provided with a battery belt 62 allowing the infrared camera to be powered while in the field.

While the patent to Piety et al is an advancement in the field of infrared cameras wherein, such a camera can be transported into the field for inspecting a piece of machinery, as shown in FIG. 2, or other surfaces to determine the existence of object points that are excessively hot as well as the temperature profile across the surface, the device shown in the Piety et al patent still has its drawbacks.

For example, the infrared camera 54 is constrained to be powered by the battery pack 62. Additionally, the lens associated with the infrared camera allowing the receipt of thermographic information is immovable relative to the display of the thermographic information. This is important because the operator shown in FIG. 2 would have to change his orientation to obtain a reading of a surface while maintaining a comfortable viewing angle. Units with fixed viewing angles would potentially cause the operator fatigue, forcing the operator to assume dangerous or even impossible positions, while taking readings of a particular surface of an object under test.

### SUMMARY OF THE INVENTION

The deficiencies of the prior art are addressed by the present invention which is directed to an infrared camera provided with a rotatable infrared camera detector unit, such as an eyeball, as well as a display screen provided on one surface of the camera, allowing an operator to view via the camera either a thermographic representation of the surface as well as a visual representation of that particular surface while maintaining a comfortable viewing stance.

The infrared camera is designed to instantly visualize the thermal radiation of various electronic components, assemblies, mechanical systems and the like. It offers thermal imaging, precision, non-contact temperature measurement, and in-field image storage, utilizing various input devices associated with the camera. The present invention would allow thermographers to highlight and analyze problems, store images, and share results with colleagues in the field, lab, or on the factory floor. Images captured in the field can be easily transferred to a computer via the appropriate wired or wireless interface or removable media.

The infrared camera is provided with an infrared camera eyeball capable of being rotated from a “parked” position in which the viewing lens and infrared detector within is protected by the infrared camera housing, to a position in which infrared information would be transmitted through the lens and iris to the appropriate infrared detector to be processed and eventually displayed on a screen provided on one exterior surface of the camera. The screen is able to both display information received by the infrared camera, as well as being utilized to control various functions and features of the digital camera.

An internal tilt sensor is utilized which would allow an “upright” image to be displayed on the display screen for viewing by the camera operator, regardless of the physical orientation of the camera with respect to an image to be viewed.

One or more exterior surfaces of the infrared camera would be provided with one or more switch devices, such as a 5-way switch for operating various features of the invention and a trigger switch for capturing an image, the image to be reviewed at a later time, either on the screen of the infrared camera or to be downloaded to a computer for viewing on the screen of that computer and/or storage for future analysis.

A strap is attached to the exterior surface of the camera, thereby allowing ease of use of the camera by the operator. The operator can, by employing the thumb and/or fingers of one hand, control the operation of the 5-way switch as well as the trigger for capturing images. The display screen could also operate as a touch screen utilizing the operator's hand or, an input device, such as a stylus.

In one alternative, the infrared camera is operated by a rechargeable battery. Alternatively, the camera may be operated with a connection to an external power source.

### BRIEF DESCRIPTION OF THE DRAWINGS

These and other aspects of the present invention will be described below in conjunction with the figures in which:

FIG. 1 is a perspective view of the infrared camera;

FIG. 2 is a first (back) side view of the infrared camera;

FIG. 3 is a second (display) side view of the infrared camera;

FIG. 4 is an end (handle) view of the infrared camera;

FIG. 5 is a (eyeball) side view of the infrared camera;

FIG. 6 is a top view of the infrared camera;

FIG. 7 is a bottom view of the infrared camera;

FIG. 8 is an exploded view of the interior of the infrared camera;

FIG. 9 is a block diagram of the signal flow of the infrared camera;

FIG. 10 shows a typical imaging display on the display screen of the infrared camera;

FIG. 11 shows another view of a typical display screen highlighting the iconic user interface menu; and

FIG. 12 is an exploded view of the hand strap of the present invention.

### DETAILED DESCRIPTION OF THE PREFERRED EMBODIMENTS

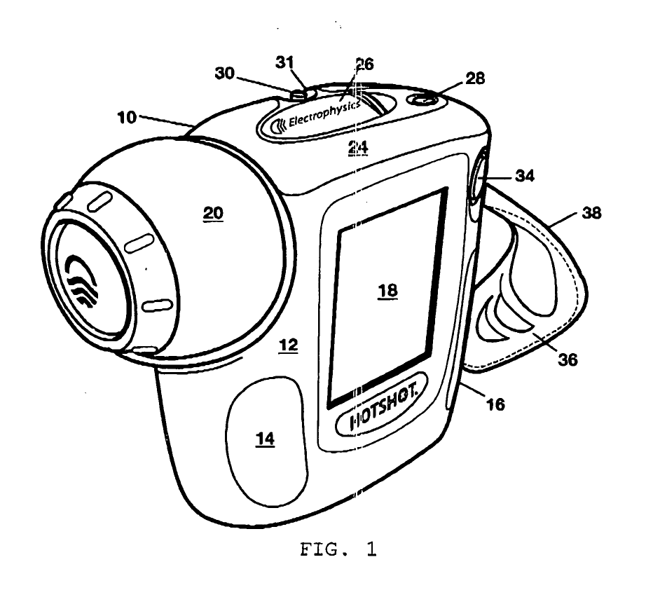

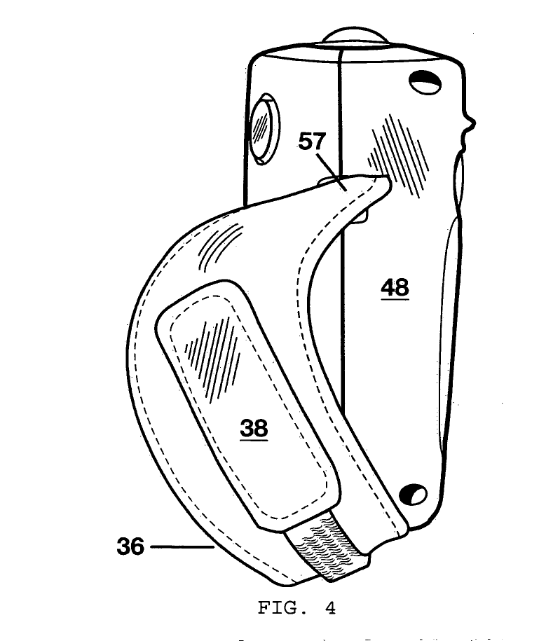

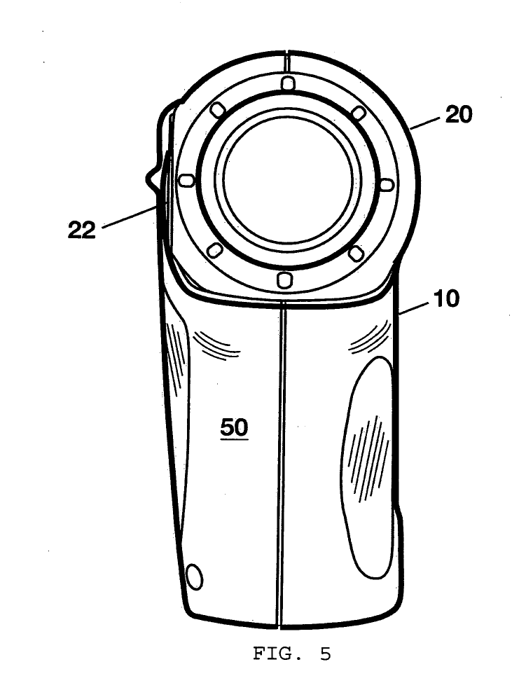

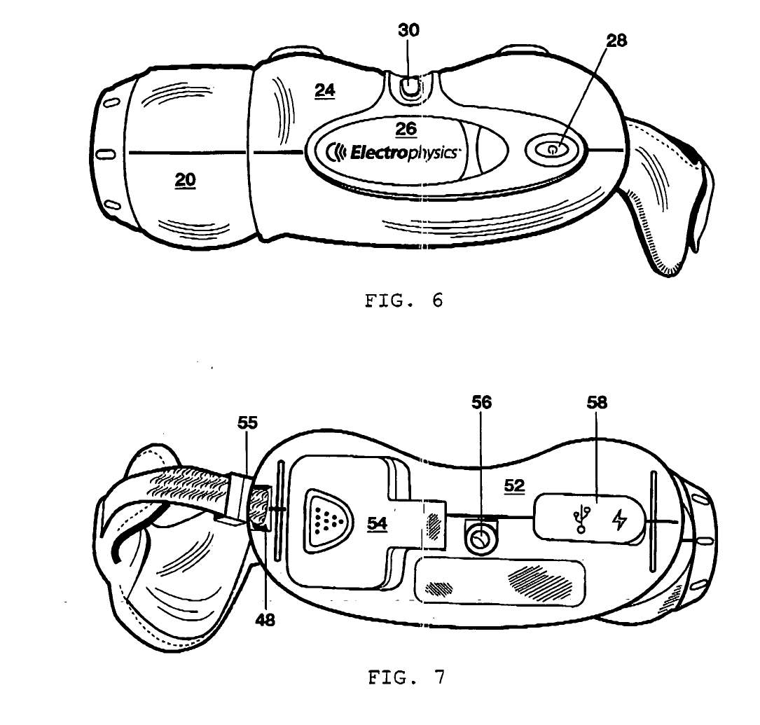

The exterior features of the infrared camera 10 are illustrated particularly with respect to FIGS. 1-7. The exterior surfaces of the camera including front and back surfaces 12 and 46, top surface 24, bottom surface 52 and side surfaces 48 and 50 may be manufactured from any hard, durable material, such as plastic.

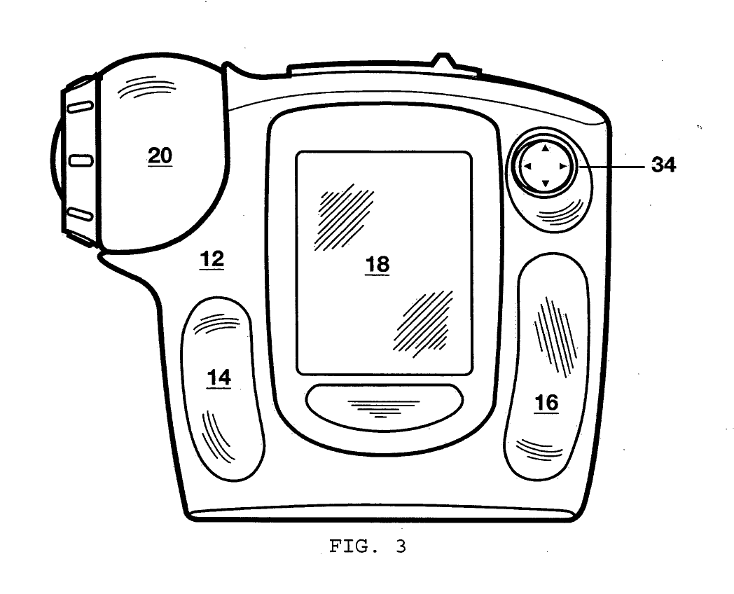

The camera 10 is provided with a lens system 22 provided within a rotatable camera eyeball 20, allowing the lens system 22, which could include more than one lens element, to be moved from the position shown in FIGS. 1-3 to a position in which a side portion of the housing 15 (see FIG. 3) would cover the lens system 22 when the infrared camera 10 is not in use (the lens “parked” position). A digital display screen with an integrated touch panel 18 is provided on one of the side surfaces, such as surface 12 of the infrared camera. Any type of display commonly utilized in this field, such as liquid crystal display could be utilized to produce the visual effects provided by the present invention. A switching device, such as a 5-way switch 34 is used to manipulate various features shown on the screen 18 as well as to focus the infrared camera. A removable stylus 30 provided within an orifice 31 on the top surface of the infrared camera could be used to enter information onto the digital touch screen 18 or to operate various menus and icons associated with the screen 18 for the purpose of controlling various features of the infrared camera, as will be subsequently discussed.

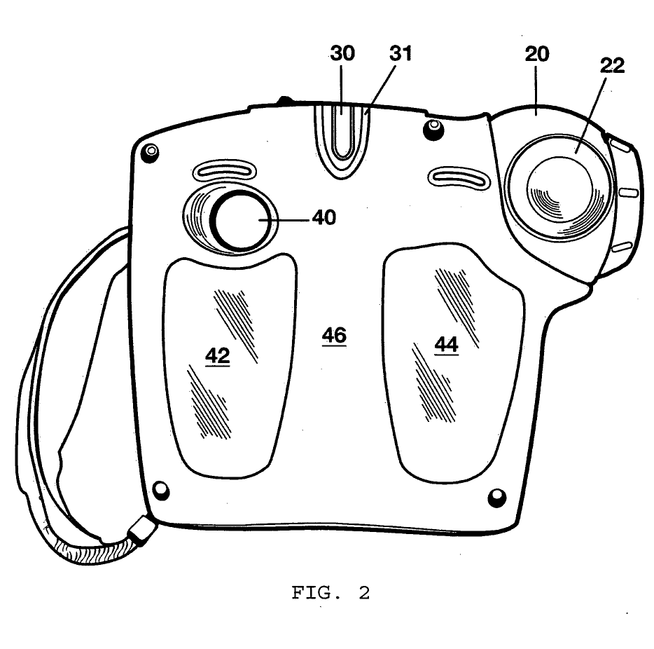

A power switch 28 is also provided on the top surface of the camera 10 as well as a removable top environmental sealing device 26 to insure that the infrared camera is properly sealed when used in various hostile environments. Removing the sealing device 26 provides access to an expansion slot into which standard accessories can be inserted for functions such as added memory, a visible light camera, a headset display, or a wireless interface. An input device, such as trigger device 40 is provided on surface 46 as shown in FIG. 2. One of the purposes of this trigger device is to allow the camera to capture and retain a particular thermographic or visual image to be reviewed at a later time. A hand strap 36 including a padded restraint 38 as well as an adjustable strap 39 is fixed to an aperture on bottom surface 52 of the infrared camera using a lower hand strap bale 55. An upper hand strap bale 57 is used to attach the strap to apertures in the side surface 48 of the infrared camera. The purpose of the hand strap would be to allow ease of use of the infrared camera by inserting one of the operator's hands therethrough.

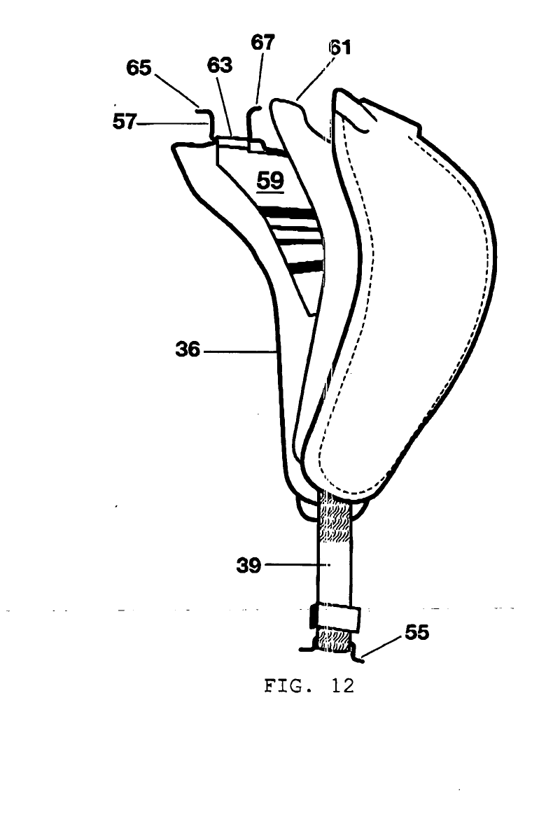

As shown in FIG. 12, the interior of the hand strap 36 is provided with a padded material 61 extending for the length of the hand strap 36. The upper hand strap bale 57 is in the form of a U-shaped connector having a bottom end 63 connected to the hand strap 36 and two top pointed ends 65 and 67 which are attached to an aperture in the side surface 48 to secure the top portion of hand strap 36 to the camera body. This configuration allows for limited movement of the strap bale 57 in the aperture in the side surface 48. Although not specifically illustrated, the construction of bottom strap bale 55 is similar to the construction of the strap bale 57 and would also allow limited movement of the bale 55 within the aperture connecting the bale 55 to the camera body. A rigid formable material 59, such as copper, plastic or the like is provided in the interior of the hand strap 36, extending from the upper hand strap bale 57 to approximately the midpoint of the hand strap 36. This formable material would be wrapped around the bottom end 63 of the upper hand strap bale 57, and would provide the upper hand strap bale 57 with rigidity needed to facilitate the one hand operation of the camera, whereby the operator would not have to squeeze the body of the camera during use. In this manner, various digits of the operator's hand as well as the operator's thumb would be free to control the 5-way switch 34 as well as the trigger 40 allowing the user to completely and comfortably support the camera while still enabling one handed operation of the camera to focus, zoom, and collect images.

Various grip surfaces such as 14, 16, 42 and 44 are also used in conjunction with the operator's hand to hold and operate the infrared camera efficiently.

The bottom surface 52 of the camera is provided with a battery door 54 in which a battery is to be housed. An environmental sealing cover 58 is used to provide electrical communication between the camera 10 and an external computer using, for example, a USB connection, and to provide optional AC powering. Additionally, although the present invention is primarily described as a portable, hand-held infrared camera, in certain situations, the camera may be attached to a tripod to monitor a particular installation for a relatively long period of time. In this instance, an aperture 56 is provided on a bottom surface 52 of the infrared camera allowing connection to the tripod.

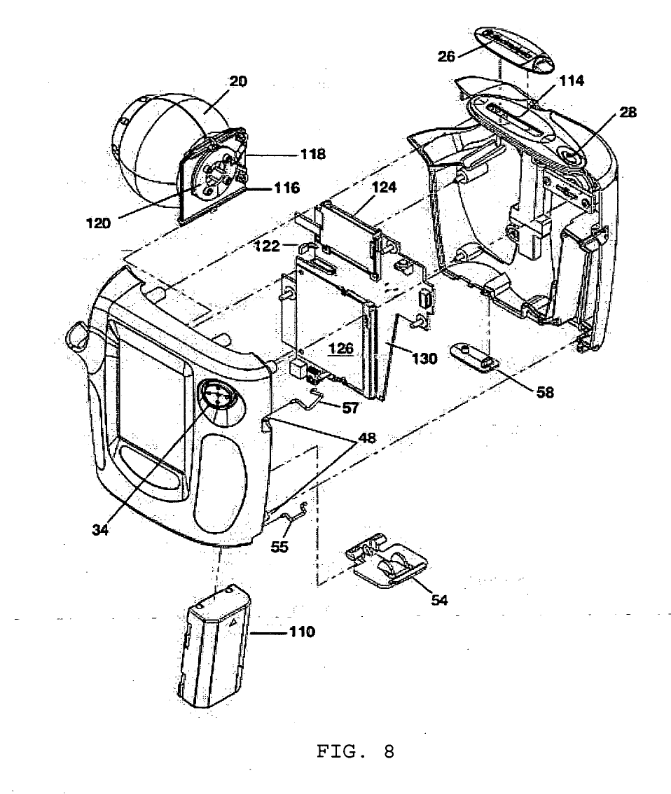

As shown in FIG. 8, the eyeball housing 20 would be rotatably affixed to the exterior housing of the infrared camera allowing the lens to rotate from a “parked” position to a position allowing both thermographic as well as visual images to be obtained. A detent plate 116 having a partially reflective surface 120 is affixed to the rear of the eyeball assembly 20 and would be provided completely within the infrared camera structure. A detent spring 118 is used along with at least one detent and the optical park sensor 122 to determine when the lens is in a position to take a thermographic image. The battery door 54 is attached to the underside of the housing, allowing a battery pack 110 to be inserted into the housing and held by a battery spring to produce the appropriate voltage for operating the infrared camera. The top environmental cover 26 is adapted to cover opening 114 which provides access to an accessories slot 124. The bottom environmental cover 58 is removable in order to provide a connection between the infrared camera and an external computer or AC power. A main circuit card assembly 130 would be provided with all of the memory in the forms of various RAMs, ROMs and EPROMs as well as digital signal processors to operate all of the functions of the infrared camera. Additionally, the display screen 18 could include a liquid crystal display 126 or similar type of display device.

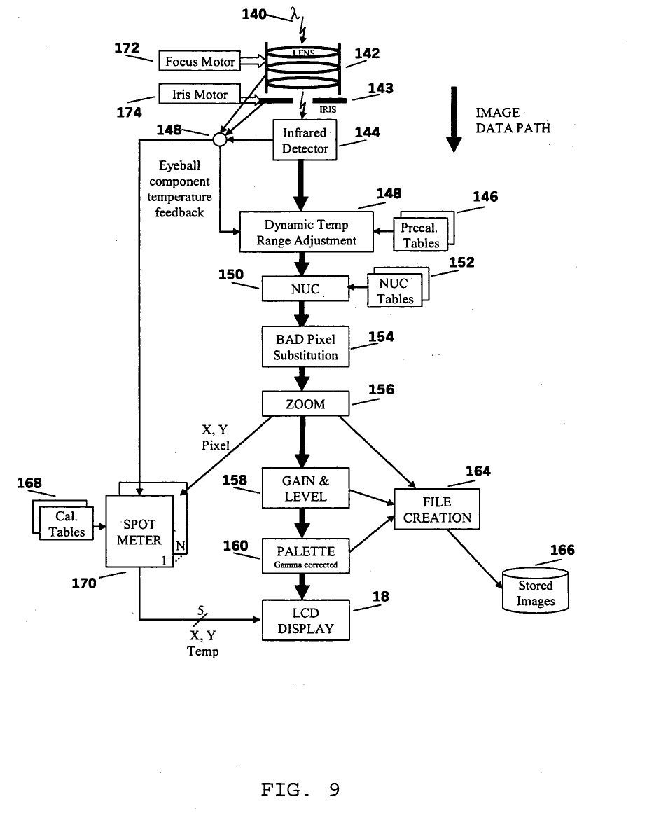

As previously described, the infrared camera is, of course, used to provide a thermographic output. To this end, an infrared energy detector, such as a microbolometer would be utilized. This is a microelectro-mechanical system (MEMS) structure which, for example, could be a 160×120 cell array of 50 micron pitch flat surfaces of silicon that are positioned to be exposed to incoming infrared radiation. The infrared energy received by individual cells would be converted to an electrical signal utilizing the fact that the structure's resistance of each cell changes with temperature. This information is utilized with the block diagram shown in FIG. 9 illustrating the basic signal flow of the infrared radiation 140 received through the input lens or lenses 142 through the display of the thermographic, or visual image on the output screen, such as a liquid crystal display 18. The infrared camera including the infrared detector 144 is designed to operate in one or more temperature ranges. Therefore, when the infrared camera is manufactured, the relevant elements must be precalibrated for each of these ranges. This precalibration information 146 is derived from empirical data and the tabulated data is retained in the memory of the CPU utilized by the camera. Therefore, once the infrared camera is activated and a particular range is chosen or defaulted, this information is used by the processor in a Dynamic Temperature Range Adjustment process 148 along with feedback on relevant component temperatures 150 to maintain the a dynamic temperature range that would keep the detector 144 in a non-saturated operating window that is as wide as possible. The objective is to obtain the best dynamic range while factoring out any contributing radiation due to the housing, lenses, or even the radiation from electronics running the detector.

A non-uniformity correction (NUC) adjustment process 150 is used to compensate for detector cell variation in gain or level across the entire detector array. As in precalibration, the NUC process is driven by empirical data collected at manufacturing time that is tabulated and stored 152 to enable the NUC process to continuously correct for non-uniformities based on temperature feedback from appropriate eyeball components 148. The objective of the NUC is to correct for differences of gain and offset shift for each pixel. The NUC process 150 can also periodically provide a field offset correction by using the iris 143. Closing the iris to provide a uniform temperature target for the detector 144 and determining the values needed to obtain the same signal reading from every cell in the MEMS array provides for the field correction.

During the operation of the detector, some of the pixels utilized may not operate properly. These are deemed to be “bad” due to excessively high or low responsivity, unsteadiness (either they flash, or slowly drift) or they tend to stop responding at some temperature levels as the temperature increases or decreases, or are stuck on or stuck off. These “bad” pixels are marked as unusable and are substituted at 154 with other adjacent pixels to provide the look and feel of a continuous scene.

Embedded processing would also operate in conjunction with user input via the 5-way switch to provide a digital zoom in or out to various magnification levels at 156.

Any pixel in the scene can be converted to a temperature value via a calibration process driven by empirical data similar to precalibration and NUC. Tabulated calibration data 168 combined with relevant eyeball component temperature feedback provide the conversions used by Spot Meters 170 which allow the user the opportunity to specify which specific points on the screen should be investigated.

The gain and level 158 as well as the color to temperature map (palette) 160 can be altered to produce the particular thermographic output or visual output on the LCD display 18. Additionally, files of various formats can be created 164 and stored at 166. These scenes can then be reviewed at a later date or downloaded utilizing a USB to a personal computer or the like.

The operation of the infrared camera will now be described with the assistance of FIGS. 11 and 12 which illustrate various types of displays generated on the LCD display 18. It is noted that these displays do not show all of the possible displays. When the camera is to be utilized, the power switch 28 would be engaged and the camera eyeball 20 of the lens system 22 would be rotated beyond the “park” position to begin accepting information. At this point, the control processor(s) of the system load the NUC tables 152. Additionally, it is noted that although it is not required for the operation of the present invention, the infrared camera of the present invention is designed to utilize the standard Windows CE operating system. The camera software application running under Windows CE displays, records and analyzes thermal images.

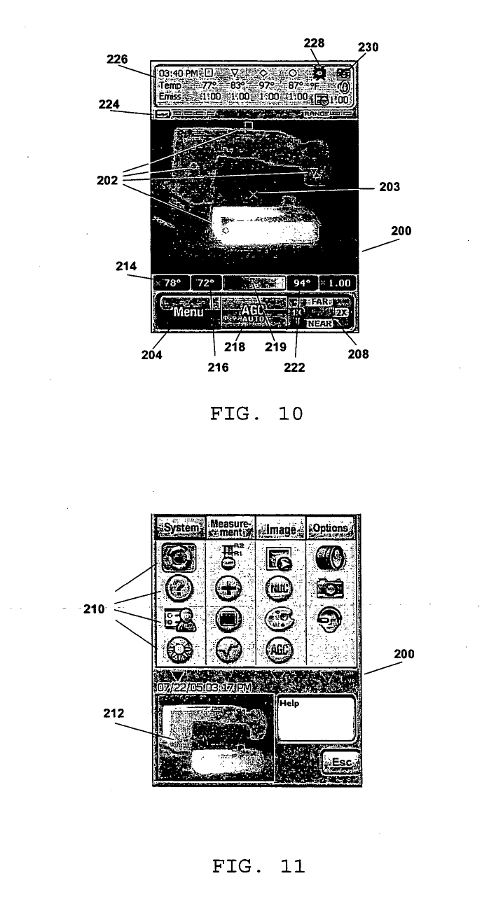

The application's front end is a Graphical User Interface (GUI) design with easy-to-understand functionality including on-screen function buttons and icons 210 (see FIGS. 10 & 11) and a series of on-screen menus that access all camera functions, user defined settings and factory setup and calibration procedures. When operating properly, the LCD screen 200 of FIG. 10 would illustrate a thermographic reading of a particular scene. This screen could also display visual images. This scene would always be upright, regardless of the orientation of the camera. A switching device, such as a tilt sensor on Main Circuit Board 130 would be utilized in combination with the embedded processor to allow for the proper orientation of the image displayed on the display 200, regardless of the orientation of the housing with respect to the vertical.

A plurality of spot points provided at various positions on the screen 202, including the center or default spot meter 203 generally included at the center of the display 200 would be used to record temperatures at each particular spot. A single spot meter reading 214 would specifically indicate the temperature of the center spot meter, while other spot meters designated by the operator are tabulated in the Readout Display Area 226. The infrared camera would measure the temperature of all of portions of the surface being viewed on display 200 and would illustrate a minimum temperature at position 216. The maximum temperature would be displayed at position 222. The spot meters 202 can also be configured to provide a differential temperature reading with the center meter 203 which would be shown in the Readout Display Area 226. These functions are operated by utilizing the appropriate menu generated by the menu icon 204 as well as the 5-way switch 34.

An Automatic Gain Control (AGC) control 218 and focus button 208 would also be used to control the operations of the present invention, particularly with respect to the use of the 5-way switch 34. Additionally, the screen can be operated utilizing the operator's touch or through the use of the stylus 30. Depressing the menu button 204 would generate various icons 210 directly on screen 200. When this occurs, an insert screen 212 is provided giving a reduced size display of the particular image.

The display screen 200 is also provided with an indicator 224 showing the status of the battery. A readout display area 226 is also provided to illustrate various conditions of the infrared camera. A palette control 219 is used to change the range of colors displayed on the screen 200.

During the course of operating the infrared camera, the operator can configure the various settings such as the LCD display brightness, emissivity and the like to default to various settings by utilizing the menu button 204 and appropriate icons 210 of the present invention.

For user convenience, there are select icons on the FIG. 10 screen that provide shortcuts to functions also accessible via the menu button 204. Examples of such shortcuts include flash control for the visible light camera 228 and visible light camera exposure and format settings 230.

As also previously indicated, a plurality of spot meters are provided on the surface of the screen. The position of the center spot meter 203 cannot be altered by the operator. However, the operator can move the position of the other spot meters 202 through the use of the touch screen and stylus 30.

The present invention would allow an operator to select an area of the screen to be further analyzed. The operator would utilize the menu button 204 in combination with icons 210 via the stylus 30 and touch screen 200 or the 5-way switch 34 to select the desired analysis tool and place the tool on the image in an area of interest. A tool such as an “area tool” (a rectangle placed over a portion of the image that summarizes the temperature results of the pixels bound by that rectangle) can be displayed on the screen 200 and the stylus 30 could be used to change the area tool size and location. The system would calculate and display in the readout area 226 the minimum temperature within the area, the maximum temperature within the area as well as the average temperature within the area.

The temperatures associated with each range, the number of ranges supported by the camera, the specific analysis tools provided, and icons support are determined by a particular camera model.

An image can be maintained in the camera when, during operation of the camera, the operator depresses the trigger switch 40. The system would then freeze the image and a status message on the screen would indicate that the image was held while the embedded processor buffers the data for file creation 164. Using touch screen 200 and 5-way switch 34 controls, the user could choose to do analysis of the frozen image and could enter various descriptive information with respect to this buffered image and ultimately allow the image to be saved in a file to non-volatile memory 166. These images can then be downloaded to a computer via a USB or recalled within the digital camera at a later time.

From the foregoing, it would be apparent that a new and improved infrared camera has been discovered. It should be understood of course that the embodiments disclosed are merely illustrative and are not intended to limit the scope of the claims.

What is claimed is:

1. A portable infrared camera, comprising:
a housing movably carried by an operator;
a first moveable infrared detector unit attached to said housing, said unit movable between a first range of rotation for the receipt of thermographic information and a second range of rotation, wherein said unit is prevented from and protected from receiving the thermographic information;
a first moveable lens structure provided within said unit; and
a first processing circuit in communication with said infrared detector unit for processing the thermographic information transmitted through said first moveable lens structure and received by said infrared detector unit.

2. The portable infrared camera in accordance with claim 1, further provided with a visible camera within said housing, a second moveable lens structure and a second processing circuit in communication with said visible camera for processing the visual information transmitted through said second moveable lens structure.

3. The portable infrared camera in accordance with claim 1, further including a display screen in communication with said processing circuit for displaying the thermographic information received by said infrared detector unit, said display screen provided on the exterior surface of said housing.

4. The portable infrared camera in accordance with claim 2, further including a memory device in communication with said first and second processing circuits and an activation device provided on the exterior surface of said housing, said memory device retaining a thermographic or visual representation of a scene, when said activation device is engaged.

5. The portable infrared camera in accordance with claim 3, further including a switching device in communication with said first processing circuit for projecting an upright image on said display screen viewable by the operator, regardless of the orientation of said housing with respect to vertical.

6. The portable infrared camera in accordance with claim 1, further including a switch means provided on the exterior surface of said housing and a focusing means provided between said first moveable lens structure and said switch means for adjusting the focus of said moveable lens structure.

7. The portable infrared camera in accordance with claim 3, further including a switch means provided on the exterior surface of said housing and a focusing means provided between said moveable lens structure and said switch means for adjusting the focus of said moveable lens structure.

8. The portable infrared camera in accordance with claim 1, further including a switch means provided on the exterior surface and detector provided in said first moveable lens structure and an iris motor assembly for opening and closing said detector.

9. The portable infrared camera in accordance with claim 3, wherein said display screen is provided with a plurality of spot meter settings, for displaying the temperature of a surface covered by at least one of said spot meter settings, said temperature displayed on said display screen.

10. The portable infrared camera in accordance with claim 9, wherein one of said spot meter settings is provided at the center of said display screen and is immovable, the remainder of said spot meter settings being moveable over said display screens.

11. The portable infrared camera in accordance with claim 10, wherein said display screen is a touch screen, used to maneuver said moveable spot meter settings.

12. The portable infrared camera in accordance with claim 1, further including a hand strap with a rigid formable insert connected to a first aperture in said housing by a first hand strap bale, allowing limited movement in said first aperture and connected to a second aperture in said housing by a second hand strap bale, allowing limited movement in said second aperture, thereby allowing the operator to operate the camera using a single hand.

13. The portable infrared camera in accordance with claim 7, further including a hand strap connected to a first aperture in said housing by a first-hand strap bale, allowing limited movement in said first aperture and connected to a second aperture in said housing by a second hand strap bale, allowing limited movement in said second aperture, thereby allowing the aperture to utilize a single hand to operate said switch means.

14. The portable infrared camera in accordance with claim 3, wherein said display screen is a touch screen and provided with a menu button, allowing a plurality of icons to be displayed thereon as well as an insert displaying the thermographic information.

15. The portable infrared device in accordance with claim 6, wherein said switch means is a 5-way switch.

16. The portable infrared device in accordance with claim 5, wherein said switching device is a tilt sensor.

17. The portable infrared device in accordance with claim 6, wherein said focusing means is a focus motor.

18. The portable infrared device in accordance with claim 7, wherein said focusing means is a focus motor.

19. The portable camera in accordance with claim 8, wherein said detector is an iris diaphragm.

20. A portable infrared camera, comprising;
a housing moveably carried by an operator;
a first moveable infrared detector unit attached to said housing for the receipt of thermographic information;
a first moveable lens structure provided within said unit;
a first processing circuit in communication with said infrared detector unit for processing the thermographic information transmitted through said first moveable lens structure and received by said infrared detector unit;
a display screen provided on the exterior surface of said housing in communication with said processing circuit; and
a switching device in communication with said processing circuit for projecting an upright image on said display screen viewable by the operator, regardless of the orientation of said housing with respect to the vertical.

21. The portable infrared camera in accordance with claim 20 wherein said switching device in a tilt sensor.

22. The portalbe infrared camera in accordance with claim 20, further provided with a visable camera within said housing, a second moveable lens structure, and a second processing circuit in communiction with said visible camera for processing the visual information transmitted through said second moveable lens structure.

23. The portable infrared camera in accordance with claim 22, further including a memory device in communication with said first and second processing circuits and an activation device provided on the exterior surface of said housing, said memory device retaining a thermographic or visual reproduction of a scene when said activation device is engaged.

24. The portable infrared camera in accordance with claim 20, further including a switch means provided on the exterior surface of said housing and a focusing means provided between said moveable lens structure and said switch means for adjusting the focus of said moveable lens structure.

25. The portable infrared camera in accordance with claim 20, further including a switch means provided on the exterior surface and detector provided in said moveable lens structure and an iris motor assembly for opening and closing said detector.

26. The portable infrared camera in accordance with claim 20, wherein said display screen is provided with a plurality of spot meter settings, for displaying the temperature of a surface covered by at least one of said spot meter settings, said temperature displayed on said display screen.

27. The portable infrared camera in accordance with claim 26, wherein one of said spot meter settings is provided at the center of said display screen and is immovable, the remainder of said spot meter settings being moveable over said display screens.

28. The portable infrared camera in accordance with claim 27, wherein said display screen is a touch screen, used to maneuver said moveable spot meter settings.

29. The portable infrared camera in accordance with claim 20, further including a hand strap with a rigid formable insert connected to a first aperture in said housing by a first hand strap bale, allowing limited movement in said first aperture and connected to a second aperture in said housing by a second hand strap bale, allowing limited movement in said second aperture, thereby allowing the operator to operate the camera using a single hand.

30. The portable infrared camera in accordance with claim 20, wherein said display screen is a touch screen and provided with a menu button, allowing a plurality of icons to be displayed thereon as well as an insert displaying the thermographic information.

31. A device for providing support to an operator of an infrared camera, comprising:
a housing movably carried by said operator;
an infrared detector unit attached to said housing;
a lens structure provided within said unit;
a hand strap having a first end connected to a first aperture provided in said housing and having a second end connected to a second aperture in said housing to allow the operator's hand to be inserted into a space produced between said hand strap and said housing to grip said housing;
a rigid formable material attached to said hand strap in proximity with said first aperture;
a first strap bale connecting said hand strap to said first aperture, said first strap bale exhibiting limited movement in said first aperture; and
a second strap bale connecting said hand strap to said second aperture;
wherein the operator can operate the camera using a single hand.

32. The device in accordance with claim 31, further including:
a focus motor provided within said housing; and
a switch means provided on the exterior surface of said housing for allowing the operator to adjust the focus of said lens through the use of a single hand.

33. The device in accordance with claim 31, further including a processing circuit in communication with said infrared camera unit for processing thermographic information transmitted through said lens structure and received by said infrared detection unit.

34. The device in accordance with claim 32, wherein said switch means is a 5-way switch.
